(19) United States
(12) Patent Application Publication
(10) Pub. No.: US 2019/0155878 A1
(43) Pub. Date: May 23, 2019

(54) METHOD, SYSTEM AND COMPUTER-READABLE RECORDING MEDIUM FOR EDITING SVG FORMAT

(71) Applicant: GREENCAT SOFTWARE CO., LTD., Anyang-si (KR)

(72) Inventor: Xavier CHO, Seoul (KR)

(73) Assignee: GREENCAT SOFTWARE CO., LTD., Anyang-si (KR)

(21) Appl. No.: 15/821,183

(22) Filed: Nov. 22, 2017

(30) Foreign Application Priority Data
Nov. 21, 2017 (KR) 10-2017-0155567

(51) Int. Cl. G06F 17/22; G06F 17/21; G06F 17/27

(52) U.S. Cl. CPC G06F 17/2264; G06F 17/272; G06F 17/218; G06F 17/2247

(57) ABSTRACT

Disclosed is a method of editing an SVG format through mapping information according to one embodiment of the present disclosure, which includes operations of generating tags of a second format corresponding to tags of a first format by substituting the tags of the first format in previously stored tag mapping information; extracting modified tags of the second format when the generated tags of the second format are modified; extracting coordinate information about objects represented through the modified tags of the second format, on a web page, and generating local coordinate information about objects represented through the tags of the first format, based on the extracted coordinate information; and updating previously stored local coordinate information about the objects represented through the tags of the first format, with the generated local coordinate information.

### CROSS-REFERENCE TO RELATED APPLICATION

This application claims priority to and the benefit of Korean Patent Application No. 10-2017-0155567, filed on Nov. 21, 2017, the disclosure of which is incorporated herein by reference in its entirety.

### BACKGROUND

### 1. Field of the Invention

The present disclosure relates to a method, system and computer-readable recording medium for editing a scalable vector graphics (SVG) format, and more particularly to a method, system and computer-readable recording medium using mapping information for editing a tag of an SVG format through a tag of a hypertext markup language (HTML) format.

The present disclosure originated from a national research and development project (Assignment number: 1711057267; Department name: Ministry of Science and Technology Ministry of Information and Communication; Research Management Institution: Institute for Information and Communications Technology Promotion (IITP); Project name: Smart media Research & Business Development (R & BD); Research title: Interactive design file development and distribution platform for effective information transmission on smart media; Contribution Rate: 1/1; Host organization: GREENCAT SOFTWARE CO., LTD; Research Period: 2017.06.01-2018.12.31).

### 2. Discussion of Related Art

Scalable vector graphics (SVG) is an extensible markup language (XML)-based file format for two-dimensional vector graphics, and is a vector graphic file format of an open standard developed under the lead of the World Wide Web Consortium (W3C) in 1999.

Since the SVG format does not support a space between lines, a paragraph, alignment, etc., there is a limit to editing content consisting of text when the SVG format is edited on a page.

Further, the SVG format supports only absolute coordinates for layout editing without a certain layout, and therefore it is impossible to make an editing-based modification such as a line break.

Conventionally, there has been disclosed a method of warping an image of the SVG format. In this method, a coordinate system for elements forming an image is modified, and elements having a fixed shape are reconstructed into elements having a plurality of points and then warped.

Although it is possible to apply warping transformation to even elements the shapes of which are difficult to be subjected to warping transformation like a quadrangle, a circle, an ellipse, etc., there is a problem in that limitations on text editing are not overcome.

### SUMMARY OF THE INVENTION

The present disclosure is directed to a method, system and computer-readable recording medium for editing an SVG format, in which coordinate information for an HTML format represented on a web page is converted into local coordinate information for the SVG format, and the converted local coordinate information is applied to the SVG format, thereby editing the SVG format.

According to an aspect of the present disclosure, there is provided a method of editing a scalable vector graphics (SVG) format, the method comprising: generating tags of a second format corresponding to tags of a first format by substituting the tags of the first format into previously stored tag mapping information; extracting modified tags of the second format when the generated tags of the second format are modified; extracting coordinate information about objects represented through the modified tags of the second format, on a web page, and generating local coordinate information about objects represented through the tags of the first format, based on the extracted coordinate information; and updating previously stored local coordinate information about the objects represented through the tags of the first format, with the generated local coordinate information.

The generation of the tags of the second format may comprise: parsing phrases included in the tags of the first format; and generating the tags of the second format by substituting the parsed phrases into the previously stored tag mapping information.

The method may further comprise: rendering the generated tags of the second format in a temporary area not provided to a user, after generating the tags of the second format.

The generation of the local coordinate information may comprise: generating local coordinate information about the objects represented through the tags of the first format by substituting the extracted coordinate information into the previously stored coordinate mapping information.

The editing of the previously stored local coordinate information may comprise: updating the previously stored local coordinate information with the generated local coordinate information so that the objects represented through tags of the first format can be located corresponding to the objects represented through the modified tags of the second format, on the web page.

The first format may comprise an SVG format, and the second format may comprise a hypertext markup language (HTML) format.

The previously stored tag mapping information may comprise conversion information between the tags of the first format and the tags of the second format.

The previously stored coordinate mapping information may comprise conversion information between local coordinate information about the objects represented through the tags of the first format and coordinate information about the objects represented through the tags of the second format, on the web page.

The previously stored local coordinate information may comprise local coordinate information about the objects represented through the tags of the first format on the web page, before modifying the tags of the second format.

According to an aspect of the present disclosure, there is provided a system for editing a scalable vector graphics (SVG) format, the system comprising an for generating tags of a second format corresponding to tags of a first format by substituting the tags of the first format into previously stored tag mapping information; extracting modified tags of the second format when the generated tags of the second format are modified; extracting coordinate information about objects represented through the modified tags of the second format, on a web page; generating local coordinate information about objects represented through the tags of the first format, based on the extracted coordinate information; and updating previously stored local coordinate information about the objects represented through the tags of the first format, with the generated local coordinate information.

The editor may parse phrases included in the tags of the first format; and generate the tags of the second format by substituting the parsed phrases into the previously stored tag mapping information.

The editor may render the generated tags of the second format in a temporary area not provided to a user.

The editor may generate local coordinate information about the objects represented through the tags of the first format by substituting the extracted coordinate information into the previously stored coordinate mapping information.

The editor may update the previously stored local coordinate information with the generated local coordinate information so that the objects represented through tags of the first format can be located corresponding to the objects represented through the modified tags of the second format, on the web page.

The first format may comprise an SVG format, and the second format may comprise a hypertext markup language (HTML) format.

The previously stored tag mapping information may comprise conversion information between the tags of the first format and the tags of the second format

The previously stored coordinate mapping information may comprise conversion information between local coordinate information about the objects represented through the tags of the first format and coordinate information about the objects represented through the tags of the second format, on the web page.

The previously stored local coordinate information may comprise local coordinate information about the objects represented through the tags of the first format on the web page, before modifying the tags of the second format.

According to an aspect of the present disclosure, there is provided a computer-readable recording medium for recording a program configured to cause a computer to execute the foregoing method of editing the SVG format.

### BRIEF DESCRIPTION OF THE DRAWINGS

The accompanying drawings, included as part of the detailed description to help understanding of the present disclosure, provide exemplary embodiments of the present disclosure and illustrate the technical features of the present disclosure together with the detailed description, in which:

FIG. 1 is a schematic flowchart of a method of editing an SVG format according to one embodiment of the present disclosure;

FIG. 2 is a schematic diagram of a system for editing an SVG format according to one embodiment of the present disclosure; and

FIGS. 3A to 3D show examples of editing an SVG format in a system, method, and computer-readable recording medium for editing the SVG format according to one embodiment of the present disclosure.

### DETAILED DESCRIPTION

In this specification, the terms “first” and/or “second,” etc. are only used to distinguish one element from another. In other words, the elements are not limited by these terms.

In this specification, the term “include” specifies the presence of the elements, features and operations, but does not preclude the presence of one or more other elements, features, operations and their equivalents.

In this specification, the singular forms are intended to include the plural forms as well, unless the context clearly indicates otherwise. That is, the elements or the like stated in this specification may mean the presence or addition of one or more other elements.

Unless otherwise defined, all terms (including technical and scientific terms) used herein have the same meaning as commonly understood by a person having an ordinary skill in the art (those skilled in the art) to which the present disclosure belongs.

It will be further understood that terms, such as those defined in commonly used dictionaries, should be interpreted as having a meaning that is consistent with their meaning in the context of the relevant art and will not be interpreted in an idealized or overly formal sense unless expressly so defined here.

Below, a method, system, and computer-readable recording medium for editing an SVG format according to an embodiment of the present disclosure will be described in detail with reference to the accompanying drawings.

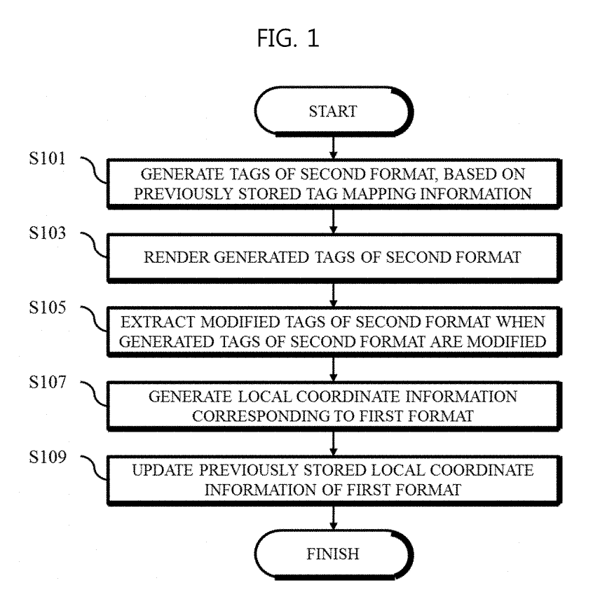

FIG. 1 is a schematic flowchart of a method of editing an SVG format according to one embodiment of the present disclosure;

Referring to FIG. 1, a method of editing the SVG format using mapping information according to one embodiment of the present disclosure includes an operation S101 of generating tags of a second format, a rendering operation S103, an operation S105 of extracting modified tags of a second format, an operation S107 of generating local coordinate information, and an editing operation S109.

The operation S101 of generating the tags of the second format includes generating the tags of the second format corresponding to tags of a first format, based on previously stored tag mapping information between the tags of the first format and the tags of the second format.

The previously stored tag mapping information refers to conversion information between the tags of the first format and the tags of the second format. For example, the tag of the first format, i.e. ‘A_SVG’ is substituted into the previously stored mapping information, and thus it is possible to generate the tag of the second format, i.e. ‘A_HTML,’ corresponding to ‘A_SVG’.

The first format may include a scalable vector graphics (SVG) format, and the second format may include a hypertext markup language (HTML) format.

Here, the scalable vector graphics (SVG) refers to an extensible markup language (XML)-based graphic format for 2-dimensional vector graphics. The SVG standards define the display effects, syntax, and features of SVG, and include an XML namespace of a module and a document object model (DOM).

The SVG not only provides a hyperlink function, but also supports a script language.

Therefore, it is possible to respond to a specific event by accessing the elements and attributes of the SVG DOM via script programming, thereby enhancing the dynamic and interactive performance of the SVG.

Phrases included in the tags of the first format are parsed, and the parsed phrases included in the tags of the first format are substituted into the previously stored tag mapping information, thereby generating the tags of the second format corresponding to the tags of the tags of the first format.

Since the SVG is based on the XML, a document-based XML parser (DOM), an event-based XML parser (Simple API for XML, SAX), a “pull” mode-based XML parser (XML Pull Parser, XPP), or the like may be employed when an SVG file is parsed.

In the operation S101 of generating the tags of the second format, semantic paragraphs are inferred from the tags of the first format, and the tags of the first format are parsed according to the paragraphs.

Further, the paragraphs are substituted into the previously stored tag mapping information, thereby generating the tags of the second format corresponding to the tags of the first format.

In the rendering operation S103, the generated tags of the second format are rendered.

Rendering means that requested content is displayed on a page screen, and a rendering engine is basically capable of displaying an HTML document, an XML document, and an image, and also displaying a portable document format (PDF) and the like using a page extension function.

For example, the rendering may include HTML parsing to build a DOM tree, render tree building, render tree laying-out, and render tree drawing.

Content of the tags of the second format may be rendered in a temporary area invisible to a user, and the tags of the second format may be modified in the temporary area while a user modifies objects represented on a web page through the tags of the second format.

In the operation S105 of extracting the modified tags of the second format, the modified tags are extracted from the modified tags of the second format when the tags of the generated second format are modified.

In the operation S107 of generating the local coordinate information, coordinate information of objects represented by the modified tags of the second format on the web page is extracted, and the local coordinate information corresponding to the first format is generated based on the extracted coordinate information.

That is, the coordinate information of the objects represented on the web page is extracted through the modified tag of the second format, and the extracted coordinate information is substituted into the previously stored coordinate mapping information, thereby generating the local coordinate information about the objects represented on the web page through the tags of the first format.

For example, when a ‘A’ word located at coordinates (0,0) in the HTML format is moved to coordinates (10,10), the ‘A’ word may have coordinate information of (10,10) in the modified HTML format. The coordinate information about the ‘A’ word is substituted into the previously stored SVG-HTML coordinate mapping information, thereby generating the local coordinate information of the SVG format corresponding to the coordinate information of (10,10) in the HTML format.

SVG 1.1 and its previous version support only absolute coordinates for a layout but not editing of a space between lines of text, a paragraph, and alignment, etc. However, it is possible to edit the space between lines of text, the paragraph, the alignment, etc. by editing the SVG format through the HTML format.

In the editing operation S109, the previously stored local coordinate information is edited with regard to the objects represented through the tags of the first format, based on the generated local coordinate information.

The previously stored local coordinate information is updated with the generated local coordinate information, so that the objects represented on the web page through the tags of the first format can be located corresponding to the objects represented through the modified tags of the second format.

For example, when the coordinate information of the ‘A’ word is modified into (10,10) in the HTML format, the local coordinate information of the SVG format may be generated corresponding to the coordinate information of (10,10) in the HTML format. Since the local coordinate information of the ‘A’ word previously stored in the SVG format is updated with the generated local coordinate information of the SVG format, the ‘A’ word of the SVG format can be represented at the same location as the ‘A’ word of the HTML format on the web page.

The web page supports SVG rendering as well as HTML rendering. When there are no changes in style attributes such as font, size and the like of text, rendering results are almost similar between the tag of the HTML format and the tag of the SVG format, and therefore it is possible to modify the tags of the SVG format on the basis of modifications in the tags of the HTML format.

With a series of operations described above, the tags of the SVG format can be updated by building a SVG DOM tree to which a text layout is applied corresponding to results from the HTML format rendered on the web page.

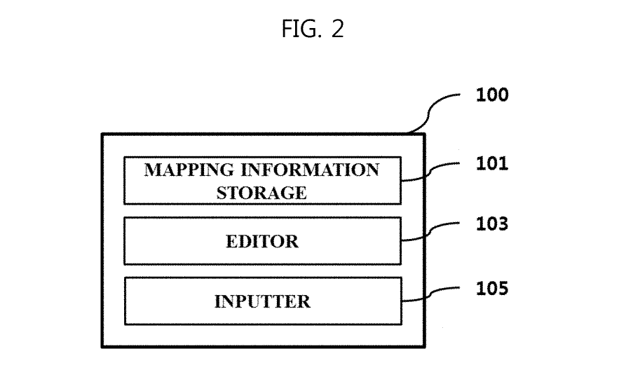

FIG. 2 is a schematic diagram of a system for editing an SVG format according to one embodiment of the present disclosure.

Referring to FIG. 2, a system 100 for editing the SVG format includes a mapping information storage 101, an editor 103 and an inputter 105.

The mapping information storage 101 may be configured to store pieces of tag mapping information and pieces of coordinate mapping information.

The tag mapping information includes conversion information between the tag of the first format and the tag of the second format.

The coordinate mapping information includes conversion information between local coordinate information about objects represented on the web page through the tags of the first format, and coordinate information about objects represented through the tags of the second format.

For example, the tag mapping information may include the conversion information about the tags of the HTML format corresponding to the tags of the SVG format.

Further, the coordinate mapping information may include the conversion information between the local coordinate information about the objects represented on the web page through the tags of the SVG format and the coordinate information about the objects represented through the tags of the HTML format.

The editor 103 may be configured to generate the tags of the second format corresponding to the tags of the first format by substituting the tags of the first format into the previously stored tag mapping information.

For example, the editor 103 generates the tag of HTML format named ‘A_HTML’ by substituting the tag of the SVG format named ‘A_SVG’ into the previously stored tag mapping information.

That is, the editor 103 parses the phrases included in the tags of the first format, and substitutes the parsed phrases into the previously stored tag mapping information, thereby generating the tags of the second format.

The tags of the second format may be rendered in the temporary area invisible to a user, and the tags of the second format may be modified in the temporary area while a user modifies the objects represented on the web page through the tags of the second format.

When a user modifies the tags of the second format through the inputter 105, the editor 103 may extract the modified tags of the second format.

Further, the editor 103 may extract the coordinate information about the objects represented on the web page through the modified tags of the second format.

For example, the editor 103 extracts the coordinate information about the object represented on the web page through the modified tags of the HTML format, and substitutes the extracted coordinate information into the previously stored coordinate mapping information, thereby generating the local coordinate information about the objects represented on the web page through the tags of the SVG format.

The editor 103 may edit the previously stored local coordinate information about the objects represented though the tags of the first format by updating the previously stored local coordinate information about the objects represented through the tags of the first format with the generated local coordinate information.

The editor 103 updates the previously stored local coordinate information about the objects represented through the tags of the first format with the generated local coordinate information, so that the objects represented on the web page through the tags of the first format can be located corresponding to the objects represented through the modified tags of the second format.

For example, the editor 103 generates the local coordinate information about the objects represented through the tags of the SVG format by substituting the coordinate information about the objects represented through the tags of the HTML format into the previously stored coordinate mapping information

Then, the previously stored local coordinate information about the objects represented through the tags of the SVG format is updated with the generated local coordinate information, thereby changing the location of the objects represented through the tags of the SVG format on the web page.

The inputter 105 is configured to receive the tag of the second format modified on the web page by a user.

That is, a user may use the inputter 105 to modify local coordinates of the object represented through the tags of the second format when the tag of the second format is rendered in the temporary area by the editor 103.

While a process progresses via user input, the editor 103 extracts the tags of the second format modified by a user, and substitutes the extracted tags of the second format into the previously stored tag mapping information, thereby generating the tags corresponding to the tags of the first format.

Further, the editor 103 may generate the local coordinate information about the objects represented through the tags of the first format by substituting the coordinate information about the objects represented on the web page through the tags of the second format into the previously stored coordinate mapping information.

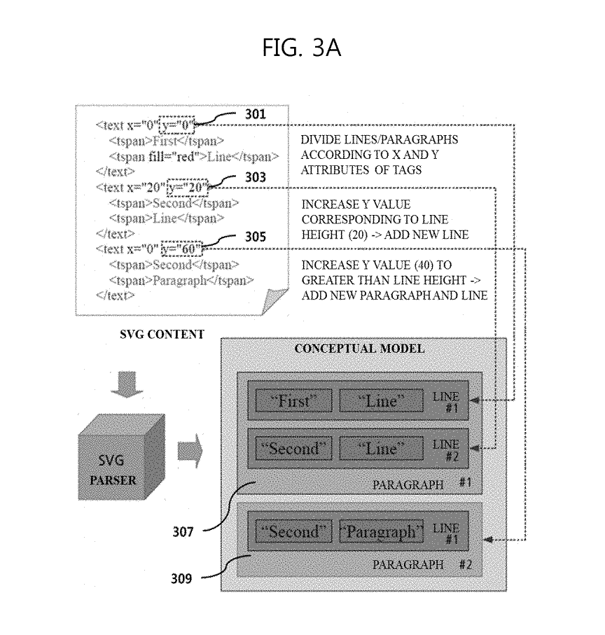

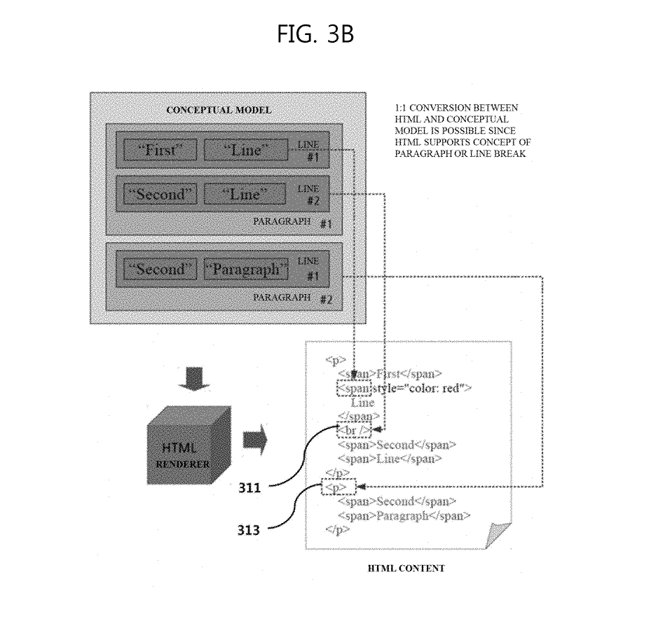

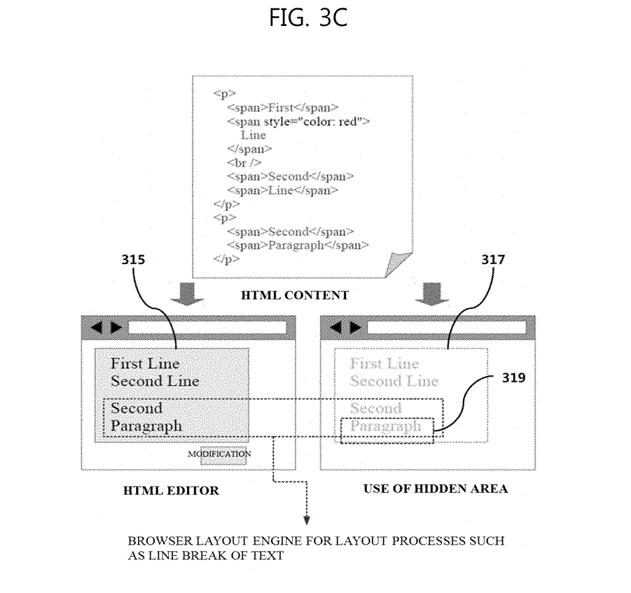

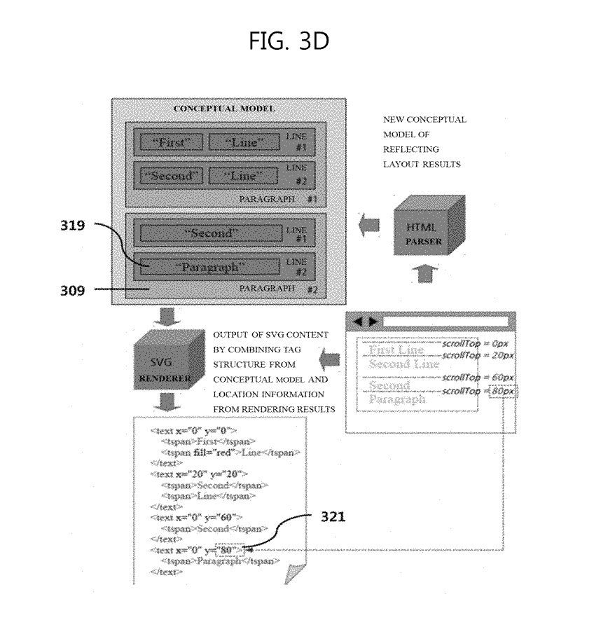

FIGS. 3A to 3D show examples of editing an SVG format in a system, method and computer-readable recording medium for editing the SVG format according to one embodiment of the present disclosure.

Specifically, FIG. 3A illustrates a conceptual model of the tags of the SVG format, FIG. 3B illustrates the tags of the HTML format corresponding to the tags of the SVG format, FIG. 3C illustrates the edited tag of the HTML format and the temporary area where the HTML format is rendered, and FIG. 3D illustrates the SVG format edited based on the modified tag of the HTML format.

Referring to FIG. 3A, the SVG format is divided into lines and paragraphs according to x and y attributes of the tags.

For example, y indicates line height, and a new line may be added to a first paragraph 307 when a second y 303 is “20”.

Further, since the second y 303 is “20”, which is increased by “20” compared to a first y 301, a new line may be added.

Since a third y 305 is “60”, which is increased by “40” compared to the second y 303, a second paragraph 309 may be added as the third y 305 is increased to be greater than the line height of “20”.

Referring to FIG. 3B, the tags of the SVG format are substituted into the previously stored tag mapping information, thereby generating the tags of the HTML format.

The first y 301 corresponds to <br/> 311 for a line break among the tags of the HTML format, and the third y 305 corresponds to <p> 313 for separating the paragraphs among the tags of the HTML format

Referring to FIG. 3C, when a user modifies the tags of the HTML format through an HTML format 315, the modified tags of the HTML format are rendered in a temporary area 317.

Referring to FIG. 3D, the tags of the SVG format are edited according to modified content of the second paragraph 309 based on the tags of the HTML format modified by a user.

The local coordinate information of the SVG format may be generated corresponding to the coordinate information about modified words of “Paragraph” 319 in the HTML format.

Since the location of “Paragraph” 319 in the second paragraph 309 is modified by user editing so as to be in the second line in the second paragraph 309, a fourth y 321 is set to “80” in the SVG format and thus it is possible to add a new line.

The “Paragraph” 319 may be located in the added new line.

Exemplary modules, operations, processes, logic blocks, means, steps or a combination thereof about the embodiments described in this specification may be implemented by electronic hardware (digital models designed by coding or the like), software (various applications including program commands) or a combination thereof. Hardware and/or software to be used in the implementation may vary depending on the design constraints imposed on a user terminal. Further, the functions described in this specification may be implemented by hardware, software, firmware or a combination thereof. In the case of using software for the implementation, the function may be stored as one or more instructions or code in a computer-readable recording medium or transmitted through the computer-readable recording medium. The computer-readable recording medium generally and collectively refers to any available medium that a computer can access.

According to one embodiment of the present disclosure, through editing the HTML format, the SVG format can be edited.

Further, through the editing of the HTML format on the web page, it is possible to perform text-related editing such as a line break, a paragraph, a space between lines and the like, which are not supported in the editing of the SVG format,

Although several exemplary embodiments of the present disclosure have been described, various modifications or changes may be made without departing from the scope defined by the appended claims, and the technical scope of the present disclosure is defined in the following claims.

### REFERENCE NUMERALS

100: system for editing SVG format
101: mapping information storage
103: editor
105: inputter
301: first y
303: second y
305: third y
307: first paragraph
309: second paragraph
311: <br/>
313: <p>
315: HTML format
317: temporary area
319: “Paragraph”
321: fourth y

What is claimed is:

1. A method of editing a scalable vector graphics (SVG) format, the method comprising:
generating tags of a second format corresponding to tags of a first format by substituting the tags of the first format into previously stored tag mapping information;
extracting modified tags of the second format when the generated tags of the second format are modified;
extracting coordinate information about objects represented through the modified tags of the second format, on a web page;
generating local coordinate information about objects represented through the tags of the first format, based on the extracted coordinate information; and
updating previously stored local coordinate information about the objects represented through the tags of the first format, with the generated local coordinate information.

2. The method of claim 1, wherein the generation of the tags of the second format comprises:
parsing phrases included in the tags of the first format; and
generating the tags of the second format by substituting the parsed phrases into the previously stored tag mapping information.

3. The method of claim 1, further comprising: rendering the generated tags of the second format in a temporary area not provided to a user, after generating the tags of the second format.

4. The method of claim 1, wherein the generation of the local coordinate information comprises:
generating local coordinate information about the objects represented through the tags of the first format by substituting the extracted coordinate information in the previously stored coordinate mapping information.

5. The method of claim 4, wherein the update of the previously stored local coordinate information comprises:
updating the previously stored local coordinate information with the generated local coordinate information so that the objects represented through tags of the first format can be located corresponding to the objects represented through the modified tags of the second format, on the web page.

6. The method of claim 1, wherein
the first format comprises an SVG format, and
the second format comprises a hypertext markup language (HTML) format.

7. The method of claim 1, wherein the previously stored tag mapping information comprises conversion information between the tags of the first format and the tags of the second format.

8. The method of claim 1, wherein the previously stored coordinate mapping information comprises conversion information between local coordinate information about the objects represented through the tags of the first format and coordinate information about the objects represented through the tags of the second format, on the web page.

9. The method of claim 5, wherein the previously stored local coordinate information comprises local coordinate information about the objects represented through the tags of the first format on the web page, before modifying the tags of the second format.

10. A system for editing a scalable vector graphics (SVG) format, the system comprising an editor for
generating tags of a second format corresponding to tags of a first format by substituting the tags of the first format into previously stored tag mapping information;
extracting modified tags of the second format when the generated tags of the second format are modified;
extracting coordinate information about objects represented through the modified tags of the second format, on a web page;
generating local coordinate information about objects represented through the tags of the first format, based on the extracted coordinate information; and
updating previously stored local coordinate information about the objects represented through the tags of the first format, with the generated local coordinate information.

11. The system of claim 10, wherein the editor parses phrases included in the tags of the first format; and generates the tags of the second format by substituting the parsed phrases into the previously stored tag mapping information.

12. The system of claim 10, wherein the editor renders the generated tags of the second format in a temporary area not provided to a user.

13. The system of claim 10, wherein the editor generates local coordinate information about the objects represented through the tags of the first format, by substituting the extracted coordinate information into the previously stored coordinate mapping information.

14. The system of claim 13, wherein the editor updates the previously stored local coordinate information with the generated local coordinate information so that the objects represented through tags of the first format can be located corresponding to the objects represented through the modified tags of the second format, on the web page.

15. The system of claim 10, wherein
the first format comprises an SVG format, and
the second format comprises a hypertext markup language (HTML) format.

16. The system of claim 10, wherein the previously stored tag mapping information comprises conversion information between the tags of the first format and the tags of the second format

17. The system of claim 10, wherein the previously stored coordinate mapping information comprises conversion information between local coordinate information about the objects represented through the tags of the first format and coordinate information about the objects represented through the tags of the second format, on the web page.

18. The system of claim 10, wherein the previously stored local coordinate information comprises local coordinate information about the objects represented through the tags of the first format on the web page, before modifying the tags of the second format.

19. A computer-readable recording medium for recording a program configured to cause a computer to execute the method of claim 1.
